(19) United States
(12) Patent Application Publication
(10) Pub. No.: US 2013/0157037 A1
(43) Pub. Date: Jun. 20, 2013

(54) SLURRY COMPOSITION, PREPREG TAPE, AND PROCESS FOR PRODUCING COMPOSITES

(71) Applicant: Roger Lee Ken Matsumoto, Newark, DE (US)

(72) Inventor: Roger Lee Ken Matsumoto, Newark, DE (US)

(73) Assignee: General Electric Company, Schenectady, NY (US)

(21) Appl. No.: 13/325,494

(22) Filed: Dec. 14, 2011

(51) Int. Cl. B32B 5/16; C08K 5/09; C08K 5/092; B28B 11/06; C04B 35/64

(52) U.S. Cl. 428/292.1; 264/131; 264/643; 524/308; 524/300

(57) ABSTRACT

Slurry and tape compositions and processes for producing CMC articles. The slurry composition contains particles of a precursor that converts to a ceramic material when heated to a firing temperature, at least one binder that is capable of adhering the particles of the ceramic precursor together to form a pliable prepreg tape, at least one liquid plasticizer, and a solvent in which the binder is dissolved. The solvent is sufficiently volatile to evaporate from the slurry composition during forming of the tape so that the tape contains less than ten weight percent of the solvent, yet the tape is also pliable as a result of the slurry composition containing a sufficient amount of the liquid plasticizer

### BACKGROUND OF THE INVENTION

The present invention generally relates to composite articles and processes for their production. More particularly, this invention is directed to slurry and tape compositions that are suitable for use in the production of ceramic matrix composite (CMC) articles and are safer to produce, use and transport.

Higher operating temperatures for gas turbines are continuously sought in order to increase their efficiency. Though significant advances in high temperature capabilities have been achieved through formulation of iron, nickel and cobalt-base superalloys, alternative materials have been investigated. CMC materials are a notable example because their high temperature capabilities can significantly reduce cooling air requirements. CMC materials generally comprise a ceramic fiber reinforcement material embedded in a ceramic matrix material. The reinforcement material may be discontinuous short fibers dispersed in the matrix material or continuous fibers or fiber bundles oriented within the matrix material, and serves as the load-bearing constituent of the CMC in the event of a matrix crack. In turn, the ceramic matrix protects the reinforcement material, maintains the orientation of its fibers, and serves to dissipate loads to the reinforcement material. Silicon-based composites, such as silicon carbide (SiC) as the matrix and/or reinforcement material, are of particular interest to high-temperature applications, for example, high-temperature components of gas turbines including aircraft gas turbine engines and land-based gas turbine engines used in the power-generating industry.

Examples of CMC materials and particularly SiC/Si—SiC (fiber/matrix) continuous fiber-reinforced ceramic composites (CFCC) materials and processes are disclosed in U.S. Pat. Nos. 5,015,540, 5,330,854, 5,336,350, 5,628,938, 6,024,898, 6,258,737, 6,403,158, and 6,503,441, and U.S. Patent Application Publication No. 2004/0067316. Such processes generally entail the fabrication of CMCs using multiple prepreg layers, each in the form of a “tape” comprising the desired ceramic fiber reinforcement material, one or more precursors of the CMC matrix material, and organic resin binders. According to conventional practice, prepreg tapes can be formed by impregnating the reinforcement material with a slurry that contains the ceramic precursor(s) and binders. Preferred materials for the precursor will depend on the particular composition desired for the ceramic matrix of the CMC component, for example, SiC powder and/or one or more carbon-containing materials if the desired matrix material is SiC. Notable carbon-containing materials include carbon black, phenolic resins, and furanic resins, including furfuryl alcohol (C₄H₃OCH₂OH). Other typical slurry ingredients include organic binders (for example, polyvinyl butyral (PVB)) that promote the pliability of prepreg tapes, and solvents for the binders (for example, toluene and/or methyl isobutyl ketone (MIBK)) that promote the fluidity of the slurry to enable impregnation of the fiber reinforcement material. The slurry may further contain one or more particulate fillers intended to be present in the ceramic matrix of the CMC component, for example, silicon and/or SiC powders in the case of a Si—SiC matrix.

After allowing the slurry to partially dry and, if appropriate, partially curing the binders (B-staging), the resulting prepreg tape is laid-up with other tapes, and then debulked and, if appropriate, cured while subjected to elevated pressures and temperatures to produce a preform. The preform is then heated (fired) in a vacuum or inert atmosphere to decompose the binders, remove the solvents, and convert the precursor to the desired ceramic matrix material. Due to decomposition of the binders, the result is a porous CMC body that may undergo melt infiltration (MI) to fill the porosity and yield the CMC component. Specific processing techniques and parameters for the above process will depend on the particular composition of the materials.

An example of a CFCC material is schematically depicted in FIG. 1 as comprising multiple laminae 12, each derived from an individual prepreg tape that comprised unidirectionally-aligned reinforcement material 14 impregnated with a ceramic matrix precursor. As a result, each lamina 12 contains the reinforcement material 14 encased in a ceramic matrix 18 formed, wholly or in part, by conversion of the ceramic matrix precursor during firing and melt infiltration.

While processes and materials of the type described above have been successfully used to produce CMC components for gas turbines and other applications, slurries and prepreg tapes used in these processes contain significant amounts of solvents that pose environmental, health and safety issues. In particular, conventional slurries often require solvents in amounts of about 50 weight percent or more in order to yield tapes that are workable as a result of containing a sufficient amount of solvent, for example, about 10 to about 20 weight percent solvent. Typical solvents, including toluene and MIBK, are toxic, necessitating the processing and handling of the slurries and tapes in controlled ventilated areas. These solvents are also flammable, with the result that the tapes must be treated as hazardous freight when shipped. In addition, burn-off of the solvents during firing of the preform results in dimensional changes that interfere with the ability to produce CMC components of consistent dimensions. Though these disadvantages might be addressed by reducing the amount of solvent used, the result is excessively rigid tapes that may be unusable for producing composite components.

### BRIEF DESCRIPTION OF THE INVENTION

The present invention provides compositions and processes for producing composite articles, and particularly to slurry and prepreg tape compositions that are safer to process, handle and transport, and also are capable of achieving greater dimensional consistency during processing to produce composite articles.

According to a first aspect of the invention, a slurry composition is provided that contains a powder comprising particles of at least one precursor, at least one binder capable of adhering the particles of the precursor together to form a tape, at least one liquid plasticizer, and a solvent in which the binder is dissolved. The solvent is sufficiently volatile to evaporate from the slurry composition during forming of the tape so that the tape contains less than ten weight percent of the solvent, yet the tape is also pliable as a result of the slurry composition containing a sufficient amount of the liquid plasticizer.

A second aspect of the invention is a nonflammable tape that comprises a fiber reinforcement material and a matrix material, the latter comprising a powder of precursor particles, one or more binders, one or more liquid plasticizers, and less than ten weight percent of one or more solvents. The tape is pliable as a result of containing a sufficient amount of the liquid plasticizer.

Another aspect of the invention is a process of using a slurry composition to produce a nonflammable tape. The process includes forming the slurry composition to contain a powder comprising particles of at least one precursor, at least one binder, at least one liquid plasticizer, and a solvent in which the binder is dissolved. A fiber reinforcement material is impregnated with the slurry composition to produce a slurry-impregnated reinforcement material, and a portion of the solvent is then evaporated from the slurry-impregnated reinforcement material to form the tape in which the particles of the precursor are adhered together by a matrix material formed by the binder. A sufficient amount of the solvent evaporates during forming of the tape to result in the tape being nonflammable and containing less than ten weight percent of the solvent, yet the tape is also pliable as a result of the slurry composition containing a sufficient amount of the liquid plasticizer.

The tape may then be further used to form a preform, which is then heated to decompose the binder and the liquid plasticizer, convert the precursor to a ceramic material and thereby form a ceramic matrix for the ceramic fiber reinforcement material.

A technical effect of the invention is that the slurry composition and prepreg tapes produced therefrom contain a limited amount of solvent, and yet the tapes are sufficiently pliable for use in lay-up processes used to produce composite materials. Preferred solvents are also less toxic than solvents typically used in the production of prepreg tapes for CMC articles, which allows the slurry and tapes to be processed and handled without requiring ventilation and allows the tapes to be shipped as non-regulated freight. Another technical effect is that, due to the limited amount of solvent in the tapes, a composite component produced from a preform formed with the tapes will undergo significantly less shrinkage, reducing dimensional changes that would otherwise interfere with the ability to produce composite components of consistent dimensions. The slurry composition and pliable prepreg tapes produced therefrom can be used to produce a wide variety of composite components, including but not limited to hot gas path components of gas turbines.

Other aspects and advantages of this invention will be better appreciated from the following detailed description.

### BRIEF DESCRIPTION OF THE DRAWINGS

FIG. 1 schematically represents a fragmentary cross-sectional view of a CMC article.

FIG. 2 schematically represents a fragmentary cross-sectional view of a prepreg tape of a type capable of being used to form the CMC article of FIG. 1.

### DETAILED DESCRIPTION OF THE INVENTION

The present invention will be described in terms of processes for producing CMC articles, including CFCC articles. CMC materials of particular interest to the invention are those containing silicon, such as CMC's containing silicon carbide as the reinforcement and/or matrix material, a particular example of which is continuous silicon carbide fibers in a matrix of silicon carbide. However, other composite materials are also within the scope of the invention, including ceramics such as silicon nitride and silicides (intermetallics) such as niobium silicide and molybdenum silicide. While various applications are foreseeable, particular applications for CMC articles of the type that can be produced with the invention include components of gas turbine engines, such as combustor liners, blades, vanes, shrouds and other components located within the hot gas path of a gas turbine.

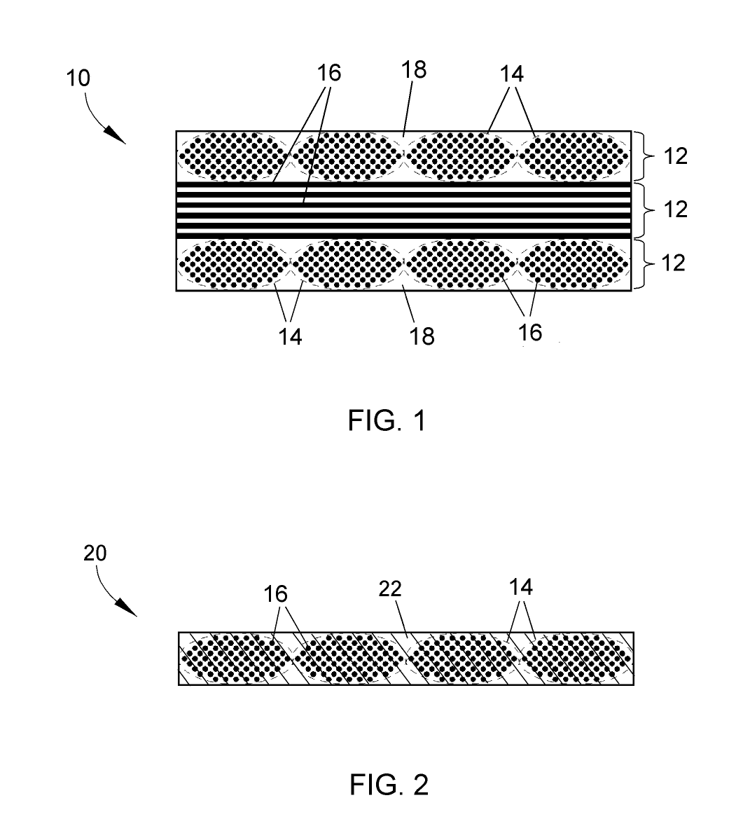

The following discussion will make reference to FIGS. 1 and 2. FIG. 1 was previously noted as representative of a CFCC component 10, though other types of CMC materials are also within the scope of the invention. As a CFCC material, the component 10 is preferably capable of offering light weight, high strength, and high stiffness for a variety of high temperature load-bearing applications. The CFCC component 10 is represented as comprising multiple laminae 12, each derived from an individual prepreg tape. Each lamina 12 contains a ceramic fiber reinforcement material 14 encased in a ceramic matrix 18 formed, wholly or in part, by conversion of a ceramic matrix precursor. As portrayed in FIGS. 1 and 2, the reinforcement material 14 is in the form of unidirectional arrays of tows, each containing continuous fibers (filaments) 16. As an alternative to unidirectional arrays of tows, the reinforcement material 14 could simply comprise fibers 16 arranged to form unidirectional arrays of fibers, or the reinforcement material 14 could comprise tows woven to form a two-dimensional fabric or woven or braided to form a three-dimensional fabric. Suitable fiber diameters, tow diameters and center-to-center tow spacings will depend on the particular application, the thicknesses of the particular lamina 12 and the tape 20 from which it was formed, and other factors, and therefore are not represented to scale in FIG. 1 or 2. Suitable fiber materials will also depend on the particular application. Notable but nonlimiting examples of CFCC materials have been developed by the General Electric Company under the name HiPerComp®, and contain continuous silicon carbide fibers in a matrix of silicon carbide and elemental silicon or a silicon alloy.

FIG. 2 schematically represents a prepreg tape 20 of a type from which each lamina 12 of FIG. 1 can be formed. As such, the tape 20 is represented as containing reinforcement material 14 in the form of tows of ceramic fibers 16, which will serve as the reinforcement phase for the component 10. The reinforcement material 14 is represented in FIG. 2 as being encased within a solid matrix material 22 formed by, among other things, one or more organic binders and one or more ceramic precursors that will form the ceramic matrix 18 of the component 10. The matrix material 22 is formed by applying a slurry composition to the reinforcement material 14, and then partially drying the slurry composition to permit handling of the tape 20. Various techniques can be used to apply the slurry composition to the reinforcement material 14, for example, by applying the slurry composition directly to a continuous strand of tow as the tow is wound onto a drum. Following the winding operation, the slurry composition can be allowed to partially dry, after which the resulting prepreg tape 20 can be removed from the drum, laid-up with other tapes, and then debulked at elevated pressures and temperatures to form a preform. The preform can then be heated in vacuum or in an inert atmosphere to decompose the binders and convert the ceramic matrix precursor into the ceramic material of the matrix 18 of the CMC component 10. The component 10 may further undergo melt infiltration to fill porosity created within the matrix 18 as a result of decomposition of the binder during firing. As a particular example, in the production of SiC/Si—SiC CMC materials, the binder can be chosen to form a carbon char as a result of the firing process, which can then be reacted with molten silicon or a molten silicon alloy during melt infiltration to form additional SiC matrix material. Specific processing techniques and parameters for the above process will depend on the particular composition of the materials and are otherwise within the capabilities of those skilled in the art, and therefore will not be discussed in any detail here.

Suitable ceramic precursors for the slurry composition will depend on the composition desired for the ceramic matrix 18 of the component 10. For the above-noted Si—SiC matrix materials used in gas turbine applications, suitable precursors include SiC, carbon, and/or one or more other carbon-containing particulate materials. Various other constituents suitable for inclusion in the slurry composition are also known and can be used. As example, the slurry composition may further contain a filler material, such as silicon carbide particles or other ceramic particulate materials that are not converted or otherwise reacted during the firing process. The ceramic precursor and any additional particulate material(s) constitute the solid constituents of the slurry composition, and preferably account for at least 30 to about 60 weight percent of the slurry composition, and more preferably about 35 to about 50 weight percent of the slurry composition.

The balance of the slurry composition is made up of liquid constituents that include at least one organic binder, at least one plasticizer, and at least one solvent in which the binder is dissolved. A preferred binder for use in the slurry composition is polyvinyl butyral (PVB), a commercial example of which is available from Solutia Inc. under the name BUTVAR® B-79. The preferred PVB binder is preferably present in an amount of at least 5 to about 10 weight percent of the slurry composition, and more preferably about 6 to about 7 weight percent of the slurry composition. Depending on their molecular weight, suitable PVB binders decompose at temperatures higher than temperatures necessary to prepare and debulk the prepreg tape 20 and less than temperatures employed to fire the preform and convert the ceramic precursor to the desired ceramic material of the matrix 18. Other potential candidates for the binder include other polymeric materials such as polycarbonate, polyvinyl acetate and polyvinyl alcohol. The selection of a suitable or preferred binder will depend in part on compatibility with the rest of the slurry components.

In contrast to prior practices in which prepreg tapes often have a solvent content of 10 weight percent or more, the tape 20 of the present invention is preferably limited to a solvent content of less than 10 weight percent, more preferably less than 7 weight percent. To compensate for the limited amount of solvent in the tape 20, which ordinarily is required to produce a pliable prepreg tape, the slurry composition is formulated so that the tape 20 produced therefrom will contain a sufficiently greater amount of the plasticizer capable of conferring the required pliability of the tape 20.

While solvents commonly used in slurry compositions include toluene and MIBK, these solvents have the disadvantage of posing environmental, safety and health issues as a result of being toxic, necessitating that such slurry compositions and prepreg tapes 20 formed therefrom must be handled in controlled environments. Furthermore, when present in typical amounts of 10 weight percent or more, burn-off of these solvents causes shrinkage that can lead to undesirable dimensional changes in the component 10 relative to the stacked prepreg tapes 20 from which the component 10 was formed. Though reducing the amount of solvent in the slurry composition to achieve a solvent content of less than 10 weight percent in the tape 20 would address these issues to some extent, an undesired effect is the loss of pliability in the tape 20 is to the degree that the tape 20 may be incapable of being laid-up to produce a preform.

A notable solvent that is suitable for use with the present invention is isopropanol (C₃H₈O), which in addition to being an effective solvent for the preferred PVB binder, is much less toxic than toluene and MIBK. Furthermore, isopropanol readily evaporates at temperatures used to prepare and debulk the prepreg tape 20, with the result that a slurry composition containing 45 weight percent or more of the solvent can produce a prepreg tape 20 having a solvent content of less than 7 weight percent. Furthermore, solvent emissions during the evaporation of isopropanol from the tape 20 are below levels requiring ventilation, and tapes 20 containing less than 10 weight percent isopropanol can be shipped as non-regulated freight. Other potential candidates for the solvent include ethanol, butanol and various acetates, which are also less toxic than toluene and MIBK and can be used in the amounts discussed above as being preferred for solvent contents in the slurry composition and tape 20.

As noted above, a sufficient amount of plasticizer is included in the slurry composition to compensate for the relatively low solvent content of the prepreg tape 20 in order to promote the pliability of the tape 20. For this purpose, the plasticizer is preferably present in the slurry composition in an amount of at least 5 to about 10 weight percent of the composition, and more preferably about 6 to about 7 weight percent of the composition. A suitable plasticizer is triethyleneglycol bis(2-ethyl hexanoate), a commercial example of which is available from Solutia Inc. under the designation S-2075. In addition to being compatible with the preferred PVB binder, S-2075 is a liquid at room temperature, with the result that this plasticizer is added as a liquid when preparing the slurry composition under room temperature conditions. Furthermore, S-2075 is non-toxic and decomposes at temperatures above 350° C., which is greater than temperatures necessary to prepare and debulk the prepreg tape 20, but less than temperatures employed to fire the preform and convert the ceramic precursor to the desired ceramic material of the matrix 18. Other potential candidates for the plasticizer include phthalates, for example, dibutyl phthalate or butyl benzyl phthalate. However, the toxicity of these plasticizers has not yet been established.

After a slurry composition is prepared to have the above-noted constituents and amounts, the composition can be applied to the reinforcement material 14 by any suitable process. The slurry composition is then allowed to partially dry through partial evaporation of the solvent, yielding the pliable prepreg tape 20 comprising the reinforcement material 14 embedded in the matrix material 22, the latter of which is formed essentially by the ceramic precursor, the binder, the plasticizer, and any particulate filler material, as well as the remaining portion of the solvent that did not evaporate during formation of the tape 20. As a result of solvent loss, the matrix material 22 within the tape 20 will typically contain, by weight, about 60 to about 70% solid powder constituent (comprising the ceramic precursor and any additional particulate materials), about 10 to about 18% binder, about 10 to about 14% plasticizer, and less than 10% (more preferably, less than 7%) solvent. The tape 20 is then laid-up with other tapes, and the prepreg tape stack is debulked at elevated pressures and temperatures to form a preform. The debulking temperature is below the decomposition temperature of the binder and plasticizer. Following debulking, during which additional solvent is evaporated, each tape 20 preferably contains less than one weight percent of the solvent, and more preferably less than 0.1 weight percent solvent. As a result of the additional loss of solvent, the tape 20 will typically contain about 25 to about 40 weight percent of the solid powder constituent formed by the ceramic precursor and any additional particulate materials, about 4 to about 8 weight percent of the binder, and about 4 to about 8 weight percent of the plasticizer, with the balance being the reinforcement material 14.

The preform can then be heated in a vacuum or inert atmosphere to a temperature sufficient to decompose the binder and the plasticizer, and then to a firing temperature sufficient to convert the ceramic precursor within the matrix material 22 into the ceramic material of the matrix 18 of the CMC component 10. As previously noted, the component 10 may further undergo melt infiltration to fill any porosity created within the matrix 18 as a result of decomposition of the binder during firing.

While discussed above in terms of prepreg processing, the invention can also be extended to fiber-reinforced composites made using other processes, including slurry casting techniques. For example, a preform of laid-up fiber cloths can be coated with a release agent and then impregnated with the slurry composition of this invention in accordance with known slurry casting techniques, followed by partial evaporation of the solvent, firing and, if necessary, melt infiltration. Accordingly, while the invention has been described in terms of specific embodiments, it is apparent that other forms could be adopted by one skilled in the art. Therefore, the scope of the invention is to be limited only by the following claims.

1. A slurry composition comprising:
a powder comprising particles of at least one precursor;
at least one binder capable of adhering the particles of the precursor together to form a pliable tape;
at least one liquid plasticizer; and
a solvent in which the binder is dissolved, the solvent being sufficiently volatile to evaporate from the slurry composition during forming of the tape so that the tape contains less than ten weight percent of the solvent, yet the tape is also pliable as a result of the slurry composition containing a sufficient amount of the liquid plasticizer.

2. The slurry composition according to claim 1, wherein the binder is polyvinyl butyral resin.

3. The slurry composition according to claim 1, wherein the solvent is isopropanol, ethanol, butanol, or an acetate.

4. The slurry composition according to claim 1, wherein the slurry composition contains at least 5 weight percent of the at least one liquid plasticizer.

5. The slurry composition according to claim 1, wherein the liquid plasticizer is triethyleneglycol bis(2-ethyl hexanoate).

6. The slurry composition according to claim 1, wherein the slurry composition contains:
about 30 to about 60 weight percent of the powder;
about 5 to about 10 weight percent of the binder;
about 5 to about 10 weight percent of the liquid plasticizer; and
the balance being the solvent.

7. A pliable nonflammable tape comprising a fiber reinforcement material and a matrix material, the matrix material comprising:
a powder comprising precursor particles;
one or more binders;
one or more liquid plasticizers; and
one or more solvents;
wherein the tape contains less than ten weight percent of the one or more solvents yet is pliable as a result of containing a sufficient amount of the one or more liquid plasticizers.

8. The pliable nonflammable tape of claim 7, wherein the tape contains less than seven weight percent of the one or more solvents.

9. The pliable nonflammable tape of claim 7, wherein the tape contains at least 4 weight percent of the at least one liquid plasticizer.

10. The pliable nonflammable tape of claim 7, wherein the solvent is isopropanol, ethanol, butanol, or an acetate.

11. The pliable nonflammable tape of claim 7, wherein the liquid plasticizer is triethyleneglycol bis(2-ethyl hexanoate).

12. A process of using a slurry composition to produce a pliable nonflammable tape, the process comprising:
forming the slurry composition to contain a powder comprising particles of at least one precursor, at least one binder, at least one liquid plasticizer, and a solvent in which the binder is dissolved;
impregnating a fiber reinforcement material with the slurry composition to produce a slurry-impregnated reinforcement material; and
evaporating at least a portion of the solvent from the slurry-impregnated reinforcement material to form the tape in which the particles of the precursor are adhered together by a matrix material formed by the binder;
wherein a sufficient amount of the solvent evaporates to result in the tape being nonflammable and containing less than ten weight percent of the solvent, yet the tape is also pliable as a result of containing a sufficient amount of the liquid plasticizer.

13. The process according to claim 12, wherein the binder is polyvinyl butyral resin.

14. The process according to claim 12, wherein the solvent is isopropanol.

15. The process according to claim 12, wherein the solvent constitutes less than 7 weight percent of the tape.

16. The process according to claim 12, wherein the liquid plasticizer is triethyleneglycol bis(2-ethyl hexanoate).

17. The process according to claim 12, wherein the liquid plasticizer constitutes at least 4 weight percent of the tape.

18. The process according to claim 12, wherein the matrix material contains:
about 60 to about 70 weight percent of the powder;
about 10 to about 18 weight percent of the binder;
about 10 to about 14 weight percent of the liquid plasticizer; and
less than 7 weight percent of the solvent.

19. The process according to claim 12, further comprising:
using the tape to form a preform;
heating the preform to decompose the binder and the liquid plasticizer; and then
further heating the preform to convert the precursor to a ceramic material, the ceramic material forming a ceramic matrix for the fiber reinforcement material.

20. The process according to claim 19, wherein the process produces a ceramic matrix composite component.
